(19) United States
(12) Patent Application Publication
(10) Pub. No.: US 2026/0252294 A1
(43) Pub. Date: Aug. 27, 2026

(54) IMAGE FORMING APPARATUS AND RESTORATION METHOD CAPABLE OF EXECUTING RESTORATION FOR EACH OPTIONAL DEVICE

(71) Applicant: KYOCERA Document Solutions Inc., Osaka (JP)

(72) Inventor: Tatsuya Majima, Osaka (JP)

(21) Appl. No.: 19/545,295

(22) Filed: Feb. 20, 2026

(30) Foreign Application Priority Data
Feb. 27, 2025 (JP) 2025-030107

(51) Int. Cl. G06F 3/12; G06F 3/0482; G06F 3/04855; H04N 1/00

(52) U.S. Cl. CPC G06F 3/1293; G06F 3/0482; G06F 3/04855; H04N 1/00411; H04N 1/00413; H04N 1/00503

(57) ABSTRACT

An image forming apparatus is connected to one or more optional devices holding setting information, and includes a storage processing portion, a reception processing portion, and a restoration processing portion. The storage processing portion stores the setting information of each of the optional devices connected to the image forming apparatus which is acquired from the optional device in a storage portion provided outside the optional device. The reception processing portion receives a designation operation for designating one of the optional devices connected to the image forming apparatus. The restoration processing portion restores the setting information of a designated device designated by the designation operation stored in the storage portion by the storage processing portion in advance in the designated device.

### INCORPORATION BY REFERENCE

This application is based upon and claims the benefit of priority from the corresponding Japanese Patent Application No. 2025-030107 filed on February 27, 2025, the entire contents of which are incorporated herein by reference.

### BACKGROUND

The present disclosure relates to an image forming apparatus and a restoration method.

There is known an image forming system including an image forming apparatus such as a multifunction peripheral and an optional device such as a post-processing device. In addition, a system is known that backs up, in an external storage device, setting information of the entire image forming system held in the image forming apparatus, and can restore the backed-up setting information in the image forming apparatus when replacing the image forming apparatus, etc.

### SUMMARY

An image forming apparatus according to one aspect of the present disclosure is connected to one or more optional devices holding setting information, and includes a storage processing portion, a reception processing portion, and a restoration processing portion. The storage processing portion stores the setting information of each of the optional devices connected to the image forming apparatus which is acquired from the optional device in a storage portion provided outside the optional device. The reception processing portion receives a designation operation for designating one of the optional devices connected to the image forming apparatus. The restoration processing portion restores the setting information of a designated device designated by the designation operation stored in the storage portion by the storage processing portion in advance in the designated device.

A restoration method according to another aspect of the present disclosure is executed by an image forming apparatus to which one or more optional devices holding setting information are connected, and includes a storage step, a reception step, and a restoration step. In the storage step, the setting information of each of the optional devices connected to the image forming apparatus which is acquired from the optional device is stored in a storage portion provided outside the optional device. In the reception step, a designation operation for designating one of the optional devices connected to the image forming apparatus is received. In the restoration step, the setting information of a designated device designated by the designation operation stored in the storage portion by the storage step in advance is restored in the designated device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming system including an image forming apparatus according to an embodiment of the present disclosure.

FIG. 2 is a block diagram showing a configuration of the image forming apparatus according to the embodiment of the present disclosure.

FIG. 3 shows an example of a reception screen displayed on the image forming apparatus according to the embodiment of the present disclosure.

FIG. 4 is a flowchart showing an example of individual restoration processing executed in the image forming apparatus according to the embodiment of the present disclosure.

### DETAILED DESCRIPTION

An embodiment of the present disclosure will be described below with reference to the accompanying drawings. It is noted that the following embodiment is an example of embodying the present disclosure and does not limit the technical scope of the present disclosure.

### Configuration of Image Forming System 100

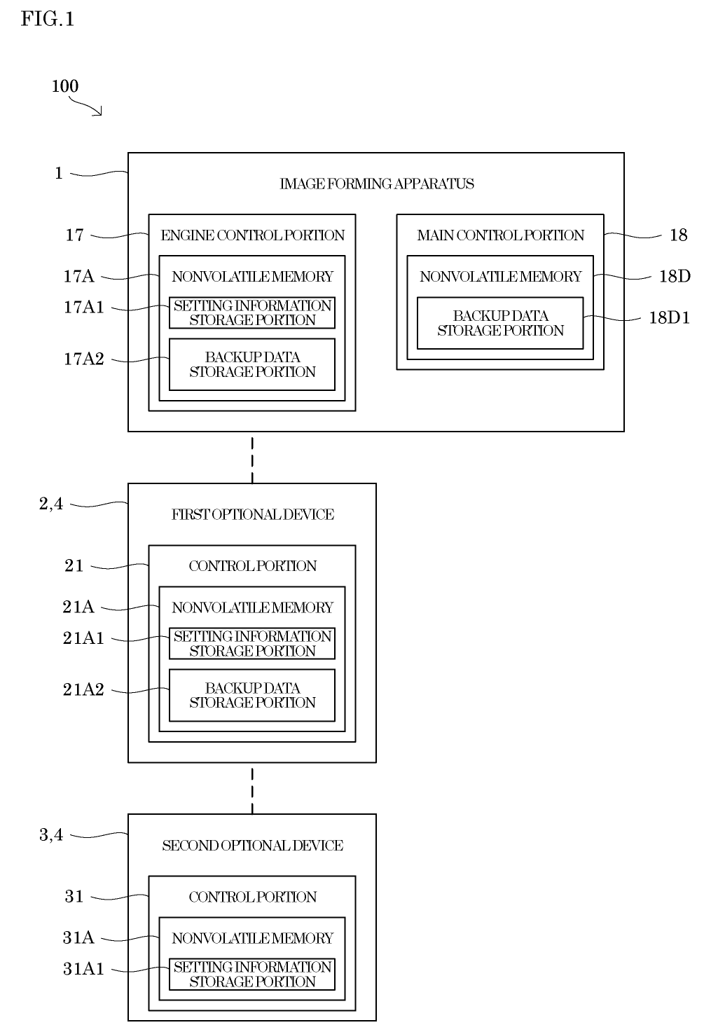

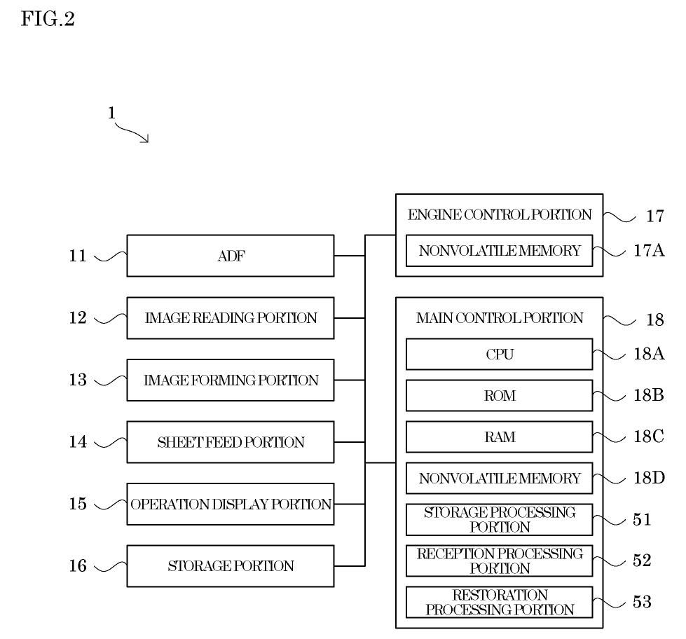

First, a configuration of an image forming system 100 including an image forming apparatus 1 according to the embodiment of the present disclosure will be described with reference to FIG. 1 and FIG. 2. It is noted that, in FIG. 1, communication paths between the constituent elements of the image forming system 100 are shown by broken lines.

As shown in FIG. 1, the image forming system 100 includes an image forming apparatus 1 and two optional devices 4 connected to the image forming apparatus 1.

One of the two optional devices 4 is a first optional device 2 communicatively connected to the image forming apparatus 1. The other of the two optional devices 4 is a second optional device 3 communicatively connected to the image forming apparatus 1 via the first optional device 2. It is noted that the number of the optional devices 4 connected to the image forming apparatus 1 is not limited to two.

The image forming apparatus 1 is a multifunction peripheral having a plurality of functions such as a facsimile function and a copy function in addition to a scan function for reading an image of a document sheet and a print function for forming an image on a sheet based on image data. It is noted that the image forming apparatus 1 is not limited to the multifunction peripheral, but may be an apparatus having the print function, such as a printer, a facsimile machine, or a copier.

As shown in FIG. 2, the image forming apparatus 1 includes an auto document feeder (ADF) 11, an image reading portion 12, an image forming portion 13, a sheet feed portion 14, an operation display portion 15, a storage portion 16, an engine control portion 17, and a main control portion 18.

The ADF 11 conveys a document sheet whose image is read by the image reading portion 12. The ADF 11 includes a document sheet loading portion, a plurality of conveying rollers, a document sheet holder, and a sheet discharge tray.

The image reading portion 12 implements the scan function. The image reading portion 12 includes a document sheet table, a light source, a plurality of mirrors, an optical lens, and a charge coupled device (CCD). The image reading portion 12 reads an image from a document sheet conveyed by the ADF 11 and outputs image data including the read image. In addition, the image reading portion 12 reads an image from a document sheet placed on the document sheet table and outputs image data including the read image.

The image forming portion 13 implements the print function. For example, the image forming portion 13 forms an image on a sheet using an electrophotographic method. The image forming portion 13 includes a plurality of image forming units corresponding to a plurality of printing colors, a laser scanning unit, an intermediate transfer belt, a secondary transfer device, a fixing device, and a sheet discharge tray. The image forming portion 13 forms a color or monochrome image, based on image data output from the image reading portion 12. In addition, the image forming portion 13 forms a color or monochrome image, based on image data input from an external information processing apparatus. It is noted that the image forming portion 13 may form an image on a sheet using a method different from the electrophotographic method, such as an inkjet method.

The sheet feed portion 14 supplies a sheet to the image forming portion 13. The sheet feed portion 14 includes a sheet feed cassette and a plurality of conveying rollers. The image forming portion 13 forms an image on a sheet supplied from the sheet feed portion 14.

The operation display portion 15 is a user interface of the image forming system 100. The operation display portion 15 includes a display portion and an operation portion. The display portion displays various types of information in response to control instructions from the main control portion 18. For example, the display portion is a display device such as a liquid crystal display. The operation portion inputs various types of information to the main control portion 18 in response to user operations. For example, the operation portion is an operation device including an operation key and a touch panel.

The storage portion 16 is a nonvolatile storage device. For example, the storage portion 16 is a solid state drive (SSD) or a hard disk drive (HDD). It is noted that the storage portion 16 may be a nonvolatile memory such as a flash memory.

The engine control portion 17 controls the ADF 11, the image reading portion 12, the image forming portion 13, and the sheet feed portion 14. For example, the engine control portion 17 is constituted by an electronic circuit such as an integrated circuit (ASIC, DSP). As shown in FIG. 2, the engine control portion 17 includes a nonvolatile memory 17A. The nonvolatile memory 17A is a nonvolatile storage device.

As shown in FIG. 1, the nonvolatile memory 17A includes a setting information storage portion 17A1 used for storing setting information (hereinafter referred to as “first setting information”) of the image forming apparatus 1. The first setting information includes various setting values related to the functions of the image forming apparatus 1, which are set by a user operation on the operation display portion 15. For example, the first setting information includes various setting values related to the scan function, various setting values related to the print function, various setting values related to the facsimile function, and various setting values related to the copy function. It is noted that the first setting information may include information indicating an operation history of each portion of the image forming apparatus 1, such as the number of operations of the image forming portion 13. In addition, the first setting information may be any rewritable information among information set or registered in the image forming apparatus 1 in advance.

The main control portion 18 performs overall control of the image forming system 100. As shown in FIG. 2, the main control portion 18 includes a CPU 18A, a ROM 18B, a RAM 18C, and a nonvolatile memory 18D. The CPU 18A is a processor that executes various types of arithmetic processing. The ROM 18B is a nonvolatile storage device in which information such as control programs for causing the CPU 18A to execute various types of processing are stored in advance. The RAM 18C is a volatile or nonvolatile storage device used as a temporary storage memory (work area) for various types of processing executed by the CPU 18A. The nonvolatile memory 18D is a nonvolatile storage device. The CPU 18A performs overall control of the image forming system 100 by executing various control programs stored in the ROM 18B in advance.

The first optional device 2 is a function expansion unit for expanding the functions of the image forming apparatus 1. Specifically, the first optional device 2 is a post-processing device that executes predetermined first post-processing on the sheet after image formation, which is output from the image forming apparatus 1. The first post-processing is stapling processing for stapling a plurality of sheets or the like. It is noted that the first optional device 2 may be a sheet feed unit that supplies a sheet to the image forming portion 13 of the image forming apparatus 1. In addition, the image forming system 100 may include a plurality of first optional devices 2 having different functions.

As shown in FIG. 1, the first optional device 2 includes a control portion 21 that controls the first optional device 2. For example, the control portion 21 is constituted by an electronic circuit such as an integrated circuit (ASIC, DSP). As shown in FIG. 1, the control portion 21 includes a nonvolatile memory 21A. The nonvolatile memory 21A is a nonvolatile storage device.

The first optional device 2 holds the setting information (hereinafter referred to as “second setting information”) of the first optional device 2. As shown in FIG. 1, the nonvolatile memory 21A includes a setting information storage portion 21A1 used for storing the second setting information. The second setting information includes various setting values related to the functions of the first optional device 2, which are set by a user operation on the operation display portion 15. For example, the second setting information includes various setting values related to a stapling function. It is noted that the second setting information may include information indicating the operation history of the first optional device 2, such as the number of times the stapling processing was executed. In addition, the second setting information may be any rewritable information among information set or registered in the first optional device 2 in advance.

The second optional device 3 is a function expansion unit for expanding the functions of the first optional device 2. Specifically, the second optional device 3 is a function expansion unit capable of executing second post-processing different from the first post-processing. The second post-processing is punching processing for punching holes in a sheet, folding processing for folding a sheet, bookbinding processing for binding a plurality of sheets, and sorting processing for sorting sheets. It is noted that, in the image forming system 100, a plurality of second optional devices 3 having different functions may be connected to a single first optional device 2. In addition, in the image forming system 100 including a plurality of first optional devices 2, one or more second optional devices 3 may be connected to each of the first optional devices 2.

As shown in FIG. 1, the second optional device 3 includes a control portion 31 that controls the second optional device 3. For example, the control portion 31 is constituted by an electronic circuit such as an integrated circuit (ASIC, DSP). As shown in FIG. 1, the control portion 31 includes a nonvolatile memory 31A. The nonvolatile memory 31A is a nonvolatile storage device.

The second optional device 3 holds the setting information (hereinafter referred to as “third setting information”) of the second optional device 3. As shown in FIG. 1, the nonvolatile memory 31A includes a setting information storage portion 31A1 used for storing the third setting information. The third setting information includes various setting values related to the functions of the second optional device 3, which are set by a user operation on the operation display portion 15. For example, the third setting information includes various setting values related to a punching function. It is noted that the third setting information may include information indicating the operation history of the second optional device 3, such as the number of times the punching processing was executed. In addition, the third setting information may be any rewritable information among the information set or registered in the second optional device 3 in advance.

By the way, in a configuration in which each of the optional devices 4 holds the setting information of the optional device 4 as in the image forming system 100, it is desirable that the setting information of the optional device 4 backed up in advance can be restored in the optional device 4 when the optional device 4 is replaced. However, conventionally, there has been no configuration in which restoration can be executed for each optional device 4.

On the other hand, in the image forming apparatus 1 according to the embodiment of the present disclosure, restoration can be executed for each optional device 4 as will be described below.

### Functional Configuration of Main Control Portion 18

Next, the functional configuration of the main control portion 18 will be described with reference to FIG. 1 and FIG. 2.

As shown in FIG. 2, the main control portion 18 includes a storage processing portion 51, a reception processing portion 52, and a restoration processing portion 53.

Specifically, the ROM 18B of the main control portion 18 stores in advance operation control programs for causing the CPU 18A to function as the respective processing portions described above. By executing the operation control programs stored in the ROM 18B, the CPU 18A functions as the respective processing portions described above.

It is noted that the operation control programs may be recorded on a computer-readable recording medium such as a CD, a DVD, or a flash memory, and may be read from the recording medium and stored in a nonvolatile storage device such as the storage portion 16. In addition, some or all of the processing portions included in the main control portion 18 may be constituted by electronic circuits. In addition, the operation control programs may be programs for causing a plurality of processors to function as the processing portions included in the main control portion 18.

The storage processing portion 51 stores the setting information of the optional device 4 connected to the image forming apparatus 1, which is acquired from the optional device 4, in a storage portion provided outside the optional device 4.

In addition, the storage processing portion 51 stores the setting information of the image forming apparatus 1 acquired from the engine control portion 17 in the nonvolatile memory 18D of the main control portion 18.

For example, the storage processing portion 51 executes third backup processing for backing up the third setting information stored in the nonvolatile memory 31A of the second optional device 3 when a predetermined execution timing arrives.

In the third backup processing, the third setting information stored in the nonvolatile memory 31A of the second optional device 3 is transferred to the first optional device 2 communicatively connected to the second optional device 3. In addition, in the third backup processing, the third setting information transferred from the second optional device 3 is backed up in the first optional device 2. Specifically, in the third backup processing, the third setting information (backup data) transferred from the second optional device 3 is stored in a backup data storage portion 21A2 (see FIG. 1) in place of the existing data stored in the backup data storage portion 21A2. It is noted that the backup data storage portion 21A2 is a storage area pre-allocated for backup purposes in the nonvolatile memory 21A.

In addition, after the execution of the third backup processing, the storage processing portion 51 executes second backup processing for backing up the second setting information and the like stored in the nonvolatile memory 21A of the first optional device 2.

In the second backup processing, the second setting information and the third setting information stored in the nonvolatile memory 21A of the first optional device 2 are transferred to the engine control portion 17. In addition, in the second backup processing, the second setting information and the third setting information transferred from the first optional device 2 are backed up in the engine control portion 17. Specifically, in the second backup processing, both of the second setting information and the third setting information (backup data) transferred from the first optional device 2 are stored in a backup data storage portion 17A2 (see FIG. 1) in place of the existing data stored in the backup data storage portion 17A2. It is noted that the backup data storage portion 17A2 is a storage area pre-allocated for backup purposes in the nonvolatile memory 17A.

In addition, after the execution of the second backup processing, the storage processing portion 51 executes first backup processing for backing up the first setting information and the like stored in the nonvolatile memory 17A of the engine control portion 17.

In the first backup processing, the first setting information, the second setting information, and the third setting information stored in the nonvolatile memory 17A of the engine control portion 17 are transferred to the main control portion 18. In addition, in the first backup processing, the first setting information, the second setting information, and the third setting information transferred from the engine control portion 17 are backed up in the main control portion 18. Specifically, in the first backup processing, all of the first setting information, the second setting information, and the third setting information (backup data) transferred from the engine control portion 17 are stored in a backup data storage portion 18D1 (see FIG. 1) in place of the existing data stored in the backup data storage portion 18D1. It is noted that the backup data storage portion 18D1 is a storage area pre-allocated for backup purposes in the nonvolatile memory 18D.

In the second backup processing, the second setting information of the first optional device 2 acquired from the first optional device 2 is stored in the backup data storage portion 17A2 (an example of the storage portion and an example of the first storage portion of the present disclosure) of the engine control portion 17 and the backup data storage portion 18D1 of the main control portion 18. In addition, in the third backup processing, the third setting information of the second optional device 3 acquired from the second optional device 3 is stored in the backup data storage portion 21A2 (an example of the storage portion and an example of the second storage portion of the present disclosure) of the first optional device 2 communicatively connected to the second optional device 3, the backup data storage portion 17A2 of the engine control portion 17, and the backup data storage portion 18D1 of the main control portion 18.

For example, the execution timing is a timing that arrives at a preset cycle. In addition, the execution timing may be a timing at which a predetermined user operation is received at the operation display portion 15.

The reception processing portion 52 receives a designation operation for designating either the optional device 4 connected to the image forming apparatus 1 or the engine control portion 17. The designation operation is an operation for designating a restoration target in which the setting information is to be restored.

Specifically, when a predetermined call operation is received at the operation display portion 15, the reception processing portion 52 causes the operation display portion 15 to display a reception screen used for the designation operation.

Here, on the reception screen, among the optional devices 4 connected to the image forming apparatus 1 and the engine control portion 17, each restorable device whose setting information is stored in the backup data storage portion 21A2, the backup data storage portion 17A2, or the backup data storage portion 18D1 by the storage processing portion 51 is presented in an identifiable manner. The restorable device is a device whose setting information has already been backed up among the optional devices 4 connected to the image forming apparatus 1 and the engine control portion 17. In addition, on the reception screen, the designation operation for designating one of the presented restorable devices is received.

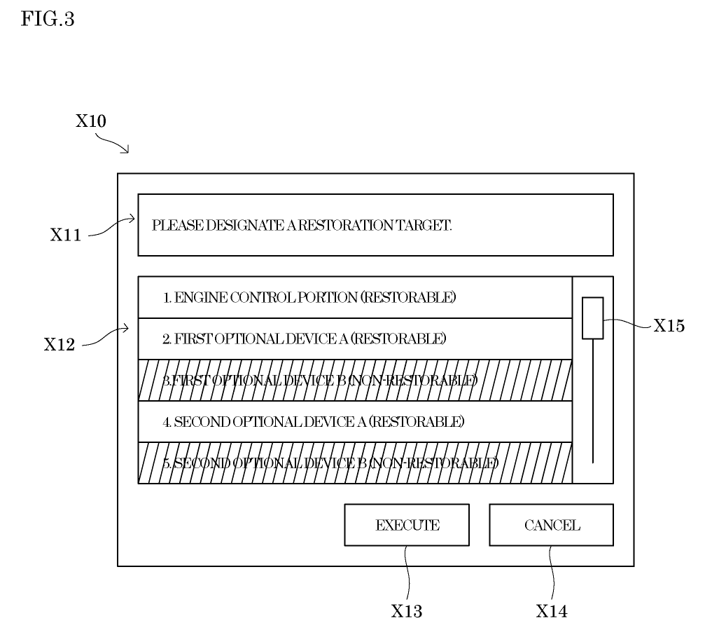

FIG. 3 shows a reception screen X10, which is an example of the reception screen when a plurality of first optional devices 2 and a plurality of second optional devices 3 are connected to the image forming apparatus 1.

As shown in FIG. 3, the reception screen X10 includes a message display field X11, a restoration target display field X12, an operation key X13, and an operation key X14.

In the message display field X11, a message to the user is displayed.

In the restoration target display field X12, the engine control portion 17 and the optional devices 4 connected to the image forming apparatus 1 are displayed. Specifically, in the restoration target display field X12, the engine control portion 17 and the names of the optional devices 4 connected to the image forming apparatus 1 are displayed in a list format.

In the restoration target display field X12, the restorable devices are displayed in an identifiable manner. For example, in the restoration target display field X12, the non-restorable devices, which are different from the restorable devices, are displayed in gray. In FIG. 3, the gray areas of the non-restorable devices are expressed by hatching. In addition, in the restoration target display field X12, the engine control portion 17 and the optional devices 4 connected to the image forming apparatus 1 are displayed together with text information indicating whether or not restoration is possible. Thus, the user can easily identify the restorable devices.

In the restoration target display field X12, the restorable devices are displayed in such a manner that they can be designated. In addition, in the restoration target display field X12, the non-restorable devices are displayed in such a manner that they cannot be designated. For example, by performing a tap operation (provisional designation operation) on any of the restorable devices included in the restoration target display field X12, the user can provisionally designate the restorable device. It is noted that, by operating a scroll bar X15 (see FIG. 3) included in the restoration target display field X12, the user can switch the display target displayed in the restoration target display field X12.

The operation key X13 is used for the designation operation. When an operation on the operation key X13 is received in a state where one of the restorable devices included in the restoration target display field X12 is provisionally designated, it is determined that the provisionally designated restorable device has been designated. It is noted that the designation operation may be an operation for designating a plurality of restorable devices.

The operation key X14 is used for a display end operation to end the display of the reception screen X10.

It is noted that, in the restoration target display field X12, only the restorable devices may be displayed.

In addition, the reception processing portion 52 may output audio data for sequentially reading the names of the restorable devices, using a speaker (not shown), thereby presenting the restorable devices in an identifiable manner.

The restoration processing portion 53 restores, in a designated device that is designated by the designation operation, the setting information corresponding to the designated device stored by the storage processing portion 51 in advance in the backup data storage portion 21A2, the backup data storage portion 17A2, or the backup data storage portion 18D1.

For example, when the designated device is the engine control portion 17, the restoration processing portion 53 executes first restoration processing for restoring the first setting information.

In the first restoration processing, the first setting information stored in the backup data storage portion 18D1 of the main control portion 18 is transferred to the engine control portion 17. In addition, in the first restoration processing, the first setting information transferred from the main control portion 18 is restored in the engine control portion 17. That is, in the first restoration processing, the first setting information (backup data) transferred from the main control portion 18 is stored in the setting information storage portion 17A1 in place of the existing first setting information stored in the setting information storage portion 17A1.

In addition, when the designated device is the first optional device 2, the restoration processing portion 53 executes second restoration processing for restoring the second setting information of the designated device.

In the second restoration processing, the second setting information of the designated device stored in the backup data storage portion 17A2 of the engine control portion 17 is transferred to the designated device. In addition, in the second restoration processing, the second setting information transferred from the engine control portion 17 is restored in the designated device. That is, in the second restoration processing, the second setting information (backup data) transferred from the engine control portion 17 is stored in the setting information storage portion 21A1 in place of the existing second setting information stored in the setting information storage portion 21A1. Thus, the time required to transfer the second setting information can be shortened as compared with the configuration in which the second setting information of the designated device stored in the backup data storage portion 18D1 of the main control portion 18 is transferred to the designated device.

In addition, when the designated device is the second optional device 3, the restoration processing portion 53 executes third restoration processing for restoring the third setting information of the designated device.

In the third restoration processing, the third setting information of the designated device stored in the backup data storage portion 21A2 of the first optional device 2 communicatively connected to the designated device is transferred to the designated device. In addition, in the third restoration processing, the third setting information transferred from the first optional device 2 is restored in the designated device. That is, in the third restoration processing, the third setting information (backup data) transferred from the first optional device 2 is stored in the setting information storage portion 31A1 in place of the existing third setting information stored in the setting information storage portion 31A1. Thus, the time required to transfer the third setting information can be shortened as compared with the configuration in which the third setting information of the designated device stored in the backup data storage portion 18D1 of the main control portion 18 or the backup data storage portion 17A2 of the engine control portion 17 is transferred to the designated device.

It is noted that, in the image forming system 100, when both the first optional device 2 and the second optional device 3 communicatively connected to the first optional device 2 are replaced at the same time, no data is stored in the backup data storage portion 21A2 of the first optional device 2 after the replacement. In this case, the restoration processing portion 53 may restore the third setting information stored in the backup data storage portion 17A2 of the engine control portion 17 in the second optional device 3 after the replacement.

### Individual Restoration Processing

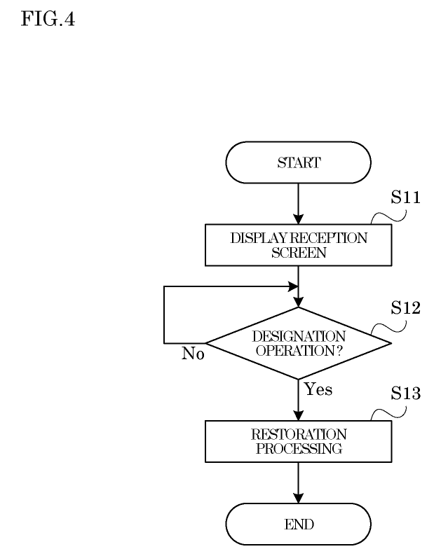

A restoration method according to the present disclosure will be described below with reference to FIG. 4, together with an example of the procedure of individual restoration processing executed by the main control portion 18 in the image forming apparatus 1. Here, steps S11, S12, ... represent the numbers of the processing procedure (steps) executed by the main control portion 18.

The main control portion 18 executes the individual restoration processing when the call operation is received at the operation display portion 15.

It is noted that, in the image forming apparatus 1, every time the execution timing arrives, the third backup processing, the second backup processing, and the first backup processing are sequentially executed by the storage processing portion 51. The second backup processing and the third backup processing are examples of the storage step of the present disclosure.

### Step S11

First, in step S11, the main control portion 18 causes the operation display portion 15 to display the reception screen. The process of step S11 is an example of the reception step of the present disclosure, and is executed by the reception processing portion 52 of the main control portion 18.

### Step S12

In step S12, the main control portion 18 determines whether or not the designation operation has been received on the reception screen.

Here, when it is determined that the designation operation has been received (Yes in S12), the main control portion 18 shifts the processing to step S13. In addition, when the designation operation has not been received (No in S12), the main control portion 18 waits for the designation operation to be received in step S12.

### Step S13

In step S13, the main control portion 18 executes restoration processing for restoring the setting information corresponding to the designated device. The process of step S13 is an example of the restoration step of the present disclosure, and is executed by the restoration processing portion 53 of the main control portion 18.

Specifically, when the designated device is the engine control portion 17, the main control portion 18 executes the first restoration processing. In addition, when the designated device is the first optional device 2, the main control portion 18 executes the second restoration processing. In addition, when the designated device is the second optional device 3, the main control portion 18 executes the third restoration processing. It is noted that, when the restoration of the setting information has failed, the main control portion 18 may cause the operation display portion 15 to display an error message indicating the failure.

In this manner, the image forming apparatus 1 receives the designation operation for designating a restoration target. In response to the designation operation, the setting information corresponding to the designated device designated by the designation operation is restored in the designated device. Thus, restoration can be executed for each of the optional devices 4.

In addition, in the image forming apparatus 1, the second setting information of the first optional device 2 acquired from the first optional device 2 is stored in the backup data storage portion 17A2 of the engine control portion 17, and the third setting information of the second optional device 3 acquired from the second optional device 3 is stored in the backup data storage portion 21A2 of the first optional device 2 communicatively connected to the second optional device 3. Thus, compared with the configuration in which the third setting information of the second optional device 3 acquired from the second optional device 3 is stored in the backup data storage portion 17A2 of the engine control portion 17 in place of the backup data storage portion 21A2 of the first optional device 2 communicatively connected to the second optional device 3, the time required to transfer the third setting information when restoring the third setting information can be shortened.

### APPENDIXES TO DISCLOSURE

The following are appendixes to the overview of the disclosure extracted from the above embodiment. It is noted that the structures and processing functions to be described in the following appendixes can be selected and combined arbitrarily.

### Appendix 1

An image forming apparatus to which one or more optional devices holding setting information are connected, the image forming apparatus comprising: a storage processing portion configured to store the setting information of each of the optional devices connected to the image forming apparatus which is acquired from the optional device in a storage portion provided outside the optional device; a reception processing portion configured to receive a designation operation for designating one of the optional devices connected to the image forming apparatus; and a restoration processing portion configured to restore the setting information of a designated device designated by the designation operation stored in the storage portion by the storage processing portion in advance in the designated device.

### Appendix 2

The image forming apparatus according to Appendix 1, wherein the reception processing portion presents, in an identifiable manner, each restorable device whose setting information is stored in the storage portion by the storage processing portion among the optional devices connected to the image forming apparatus, and receives the designation operation for designating one of the presented restorable devices.

### Appendix 3

The image forming apparatus according to Appendix 1 or 2, wherein the optional devices include a first optional device communicatively connected to the image forming apparatus, and a second optional device communicatively connected to the image forming apparatus via the first optional device, the storage portion includes a first storage portion provided in the image forming apparatus and a second storage portion provided in the first optional device, and the storage processing portion stores the setting information of the first optional device acquired from the first optional device in the first storage portion, and stores the setting information of the second optional device acquired from the second optional device in the second storage portion of the first optional device communicatively connected to the second optional device.

### Appendix 4

The image forming apparatus according to Appendix 3, wherein the storage processing portion stores the setting information of the second optional device acquired from the second optional device in the first storage portion and the second storage portion of the first optional device communicatively connected to the second optional device.

### Appendix 5

A restoration method executed by an image forming apparatus to which one or more optional devices holding setting information are connected, the restoration method comprising: a storage step of storing the setting information of each of the optional devices connected to the image forming apparatus which is acquired from the optional device in a storage portion provided outside the optional device; a reception step of receiving a designation operation for designating one of the optional devices connected to the image forming apparatus; and a restoration step of restoring the setting information of a designated device designated by the designation operation stored in the storage portion by the storage step in advance in the designated device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus to which one or more optional devices holding setting information are connected, the image forming apparatus comprising: a storage processing portion configured to store the setting information of each of the optional devices connected to the image forming apparatus which is acquired from the optional device in a storage portion provided outside the optional device;
a reception processing portion configured to receive a designation operation for designating one of the optional devices connected to the image forming apparatus; and a restoration processing portion configured to restore the setting information of a designated device designated by the designation operation stored in the storage portion by the storage processing portion in advance in the designated device.

2. The image forming apparatus according to claim 1, wherein
the reception processing portion presents, in an identifiable manner, each restorable device whose setting information is stored in the storage portion by the storage processing portion among the optional devices connected to the image forming apparatus, and receives the designation operation for designating one of the presented restorable devices.

3. The image forming apparatus according to claim 1, wherein
the optional devices include a first optional device communicatively connected to the image forming apparatus, and a second optional device communicatively connected to the image forming apparatus via the first optional device,
the storage portion includes a first storage portion provided in the image forming apparatus and a second storage portion provided in the first optional device, and
the storage processing portion stores the setting information of the first optional device acquired from the first optional device in the first storage portion, and stores the setting information of the second optional device acquired from the second optional device in the second storage portion of the first optional device communicatively connected to the second optional device.

4. The image forming apparatus according to claim 3, wherein
the storage processing portion stores the setting information of the second optional device acquired from the second optional device in the first storage portion and the second storage portion of the first optional device communicatively connected to the second optional device.

5. A restoration method executed by an image forming apparatus to which one or more optional devices holding setting information are connected, the restoration method comprising: a storage step of storing the setting information of each of the optional devices connected to the image forming apparatus which is acquired from the optional device in a storage portion provided outside the optional device;
a reception step of receiving a designation operation for designating one of the optional devices connected to the image forming apparatus; and a restoration step of restoring the setting information of a designated device designated by the designation operation stored in the storage portion by the storage step in advance in the designated device.
